(19) United States
(12) Patent Application Publication
(10) Pub. No.: US 2007/0248223 A1
(43) Pub. Date: Oct. 25, 2007

(54) COMMUNICATION CHANNEL ACTIVATION SWITCH APPARATUS

(76) Inventor: Henry Liou, Brea, CA (US)

Correspondence Address: ERIK M. VIEIRA, P. O. BOX 13593, LA JOLLA, CA, 92039, US

(21) Appl. No.: 11/678,560

(22) Filed: Feb. 23, 2007

Related U.S. Application Data
(62) Division of application No. 11/187,322, filed on Jul. 21, 2005.
(62) Division of application No. 11/187,181, filed on Jul. 21, 2005.
(62) Division of application No. 10/989,195, filed on Nov. 10, 2004.
(62) Division of application No. 10/922,742, filed on Aug. 19, 2004.
(60) Provisional application No. 60/778,174, filed on Feb. 28, 2006.

(51) Int. Cl. H04M 9/00

(52) U.S. Cl. 379/422

(57) ABSTRACT

A communication channel activation switch apparatus is disclosed. In one embodiment, the communication channel activation switch apparatus functions to open a communication channel for transmission and/or reception of information. The information transmitted and/or received may be audio and/or data information.

### CROSS-REFERENCE TO RELATED APPLICATIONS

This non-provisional patent application claims a benefit of priority to previously filed U.S. provisional patent application No. 60/778,174, filed Feb. 28, 2006 to Liou, entitled COMMUNICATION CHANNEL ACTIVATION SWITCH APPARATUS. This patent application is related to pending U.S. divisional application Ser. No. 11/187,322, filed Jul. 21, 2005 to Liou, entitled GPS MICROPHONE FOR COMMUNICATION SYSTEM; to issued U.S. Pat. No. 6,912,397 to Liou, entitled GPS MICROPHONE FOR COMMUNICATION SYSTEM, issued Jun. 28, 2005; to issued U.S. Pat. No. 6,941,147 to Liou, entitled GPS MICROPHONE FOR COMMUNICATION SYSTEM, issued Sep. 6, 2005. This application is further related to co-pending non-provisional application Ser. No. 11/165,653, filed Jun. 24, 2005 to Liou, entitled SELF-POWERED POSITIONING AND MODEM SYSTEM FOR RADIO/AUDIO COMMUNICATION DEVICE; to co-pending divisional application Ser. No. 11/187,181, filed Jul. 21, 2005 to Liou, entitled GPS MICROPHONE FOR COMMUNICATION SYSTEM; to co-pending divisional application Ser. No. 10/989,195, filed Nov. 10, 2004 to Liou, entitled GPS MICROPHONE FOR COMMUNICATION SYSTEM; and, to co-pending divisional application Ser. No. 10/922,742, filed Aug. 19, 2004 to Liou, entitled GPS MICROPHONE FOR COMMUNICATION SYSTEM. All of the U.S. patents and pending applications described above are hereby incorporated by reference herein, in their entirety, as if set forth in full.

### BACKGROUND

1. Field

The present disclosure generally relates to apparatuses for activating a communication channel.

2. Related Art

Switching devices are pervasive in modern society. From mechanical switches to transistor switches, nearly every technological device in the commercial marketplace includes one or more switching devices therein. Such devices for switching vary, depending upon a particular application.

In some applications, a user may desire to use a switch to activate a communication channel. Although many mechanical switches have been developed to provide such switching capabilities, a problem arises when the dexterity of a user is compromised. Examples of a user having his/her dexterity compromised arise in the context of, for example civil service providers (e.g., police, firefighters) and military personnel (e.g., soldiers) in field operations. In such operations, dexterity may be limited for a variety of reasons, including limited visibility (e.g., smoke, dust) or apparel such as gloves. As such, a need arises for a switching apparatus, which is cost-effective, accurate, robust, and provides ease of use for users having limited dexterity. Particularly, such a need arises when such a communication channel may be necessary to save lives by alerting support in a combat situation, police operation, or firefighting rescue operation.

Therefore, the present teachings provide such a switching apparatus, which is inexpensive, robust, accurate and easily implemented in a currently existing communications system.

### SUMMARY

An apparatus for activating a communication channel adapted for use in a communication system is disclosed. The apparatus comprises a switching element, adapted to activate a communication channel, and a housing. The housing comprises a front housing element, mechanically connected to a housing grill, wherein the housing grill is adapted to fit a speaker element therein; a tension ring, mechanically coupled to the speaker element, wherein the tension ring is adapted to provide a restoring force, and; a back housing element, mechanically coupled to the front housing element, wherein the back housing element comprises the switching element disposed therein.

A system for opening a channel in a communication system is disclosed. The system comprises a switching element, adapted to open a communication channel to a communication system, and a switching element housing. The switching element housing comprises a front housing element, mechanically connected to a housing grill, wherein the housing grill is adapted to fit a speaker element therein. The switching element housing further comprises a tension ring, mechanically coupled to the speaker element, wherein the tension ring is adapted to provide a restoring force; a back housing element, mechanically coupled to the front housing element, wherein the back housing element comprises the switching element disposed therein.

### BRIEF DESCRIPTION OF THE DRAWINGS

Embodiments of the present disclosure will be more readily understood by reference to the following figures, in which like reference numbers and designations indicate like elements.

FIG. 1a illustrates a perspective exploded view of one embodiment according to the present teachings.

FIG. 1b illustrates an alternate perspective exploded view according to the present teachings.

FIG. 1c illustrates an alternate perspective exploded view of FIG. 1b according to the present teachings

FIG. 2 illustrates a front plan view of one embodiment, in accordance with the present teachings.

FIG. 3a and 3b illustrates side perspective views, according to one embodiment of the present teachings.

FIG. 3c illustrates a rear plan view, according to one embodiment of the present teachings.

### DETAILED DESCRIPTION

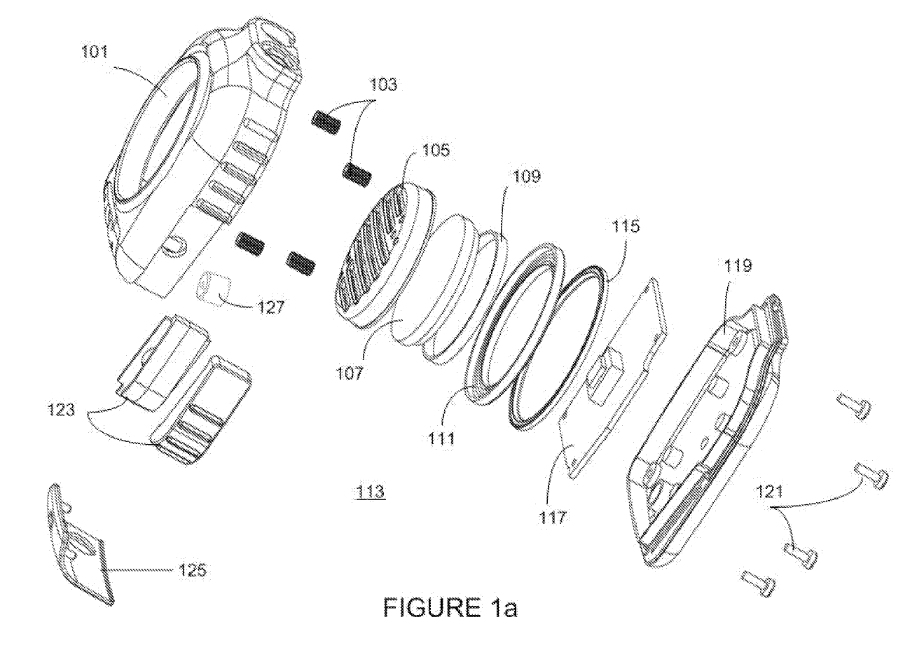

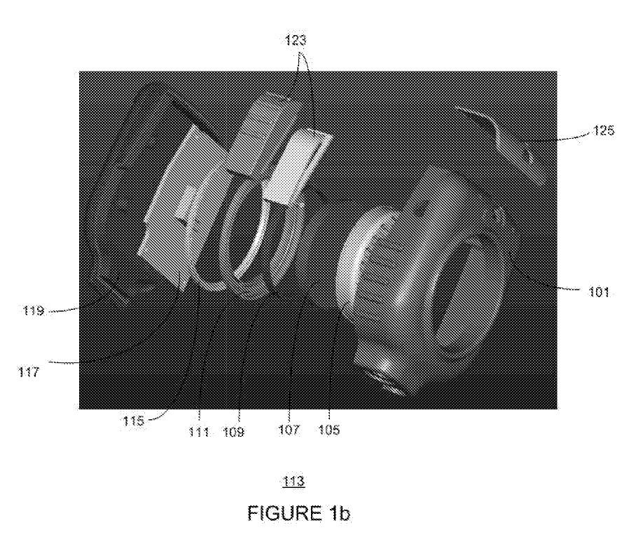

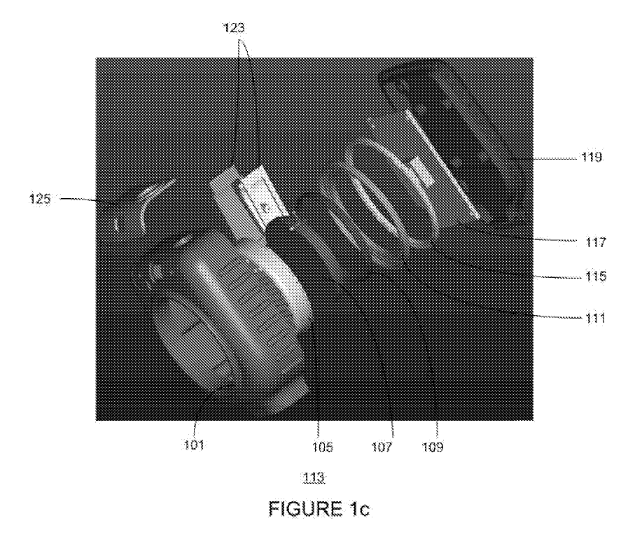

Referring now to FIGS. 1a-c, in one illustrative exemplary embodiment, a communication channel activation switch apparatus 113 is disclosed. FIGS. 1a-c shows a perspective, exploded view of the communication channel activation switch apparatus 113. The communication channel activation switch apparatus 113 comprises a front housing element 101, at least one post 103, a housing grill 105, a speaker element 107, a gasket 109, a cap 111, a tension ring 115, a switching element 117, a back housing element 119, a microphone element 127, and at least one assembly element 123 125. In one embodiment, the communication channel activation switch apparatus comprises a push-to-talk (“PTT”) speaker-microphone unit, as will be described further below.

As shown in FIGS. 1a-c, the front housing element 101 has an annular opening disposed therein. The housing grill 105 has a front portion, which is adapted to fit within the annular opening disposed on the front housing element 101. In one embodiment, the front portion of the housing grill 105 fits through the annular opening of the front housing element 101. The housing grill 105 functions to cover and protect the speaker element 107. The housing grill also functions as a switch trigger mechanism, as will be described in greater detail below. The speaker element 107 has a front portion and a rear portion. The front portion of the speaker element 107 is disposed inside the housing grill 105. The rear portion of the speaker element 107 fits inside the gasket 109. In one embodiment, the gasket functions to seal the speaker element 107 rear portion against fluids, such as for example water from entering portions of the communication channel activation switch apparatus 113 electrical circuitry (not shown). In one embodiment, the gasket is composed of silicon. When fit together, the housing grill 105, the speaker element 107, and the gasket 109 fit approximately inside the cap 111. In one embodiment, the cap 111 comprises at least one annular detent therein. The at least one annular detent functions to facilitate the fit of the aforementioned components of the communication channel activation switch apparatus 113 just described.

The tension ring 115 fits between the cap 111 and the switching element 117. In one embodiment, the tension ring 115 functions as a spring to provide a return force in accordance with Equations 1.
F=−kx Equation 1:

In Equation 1, Hooke's Law, “F”, the restoring (return) force, is a simple linear function of a vector difference in position between two points “x”, having a spring constant “k”. It will be appreciated that “k” will vary in different embodiments, depending upon specific applications and requirements. Those of ordinary skill in the art often refer to “k” as a spring's “tightness”. In one embodiment, the tension ring 115 is composed of silicon. The tension ring 115 fits over a top portion of the switching element 117. The switching element 117 fits approximately within the back housing element 119.

In one embodiment, the microphone element 127 is disposed within the front housing element 101. However, in other embodiments, the microphone element 127 may be disposed in alternate locations, either interior to the front housing element 101, or exterior to the front housing element 101, as necessitated by specific design requirements. The at least one assembly element 123 125 function to mechanically hold together the fully assembled communication channel activation switch apparatus 113.

When assembled, a user of the communication channel activation switch apparatus 113 triggers activation of the microphone element 127 by applying mechanical pressure to the housing grill 105. The housing grill 105 has a front portion, which, in one embodiment, fits through an annular opening in the front housing element 101. In one exemplary embodiment, when a user applies mechanical pressure to the housing grill 105, speaker element 107 is depressed rear-ward with respect to the housing, into the communication channel activation switch apparatus 113, whereby the speaker element 107 mechanically contacts the switching element 117. When the switching element 117 is mechanically contacted by the speaker element 107, electronic circuitry (not shown) is operationally activated to open a communication channel. In one embodiment, activation of a communication channel comprises activation of the microphone element 127, wherein the microphone element 127 is adapted to receive audio information communicated thereto. In one embodiment, a restoring force “F” is provided via the tension ring 115. The restoring force functions to return the speaker element 107 to its initial position, prior to when the user depressed the housing grill 105, thereby mechanically decoupling the speaker element 107 from the switching element 117. In this embodiment, when the speaker element 107 and the switching element 117 are mechanically decoupled, connectivity to the communication channel is closed. That is, when the restoring force acts to return the speaker element 107 to its pre-depressed position, connection to the communication channel is deactivated.

Alternate embodiments of the present disclosure include different switching elements 113. In one alternate embodiment, the switching element 113 comprises an inductive-type switching element. In an inductive-type switching element embodiment, no mechanical contact from the speaker element 107 is required. As such, a user activates a communication channel in the same manner as with other embodiments heretofore described, except that the speaker element 107 functions to activate switching element 117 via inductive coupling. In this embodiment, no mechanical contact is necessary to achieve activation of the communication channel via the switching element 117, because magnetic fields are employed to provide the force necessary to actuate the switching element 117. In one embodiment, a rod and coil inductive arrangement is employed to inductively couple the speaker element 107 to the switching element 117.

In yet another alternate embodiment of the present disclosure, a capacitive-type coupling switching mechanism may be employed. In this embodiment, mechanical contact between the speaker element 107 and the switching element 117 is unnecessary, because capacitive coupling provides the force for actuating the switching element 117, via an electric field. In one embodiment, parallel plate capacitors may be employed to activate the switching element 117.

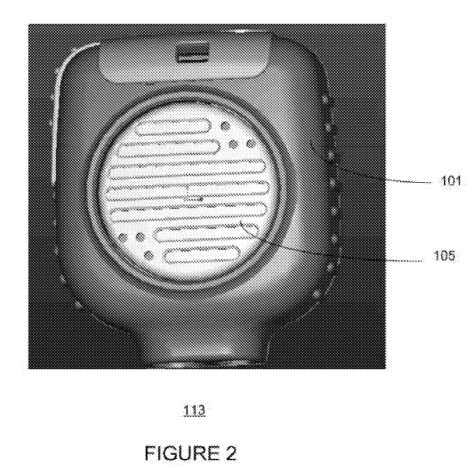

FIG. 2 shows a front plan view of a fully assembled communication channel activation switch apparatus 113 as illustrated. As described above, activation of an audio communication channel is initiated by a user applying mechanical pressure to the housing grill 105.

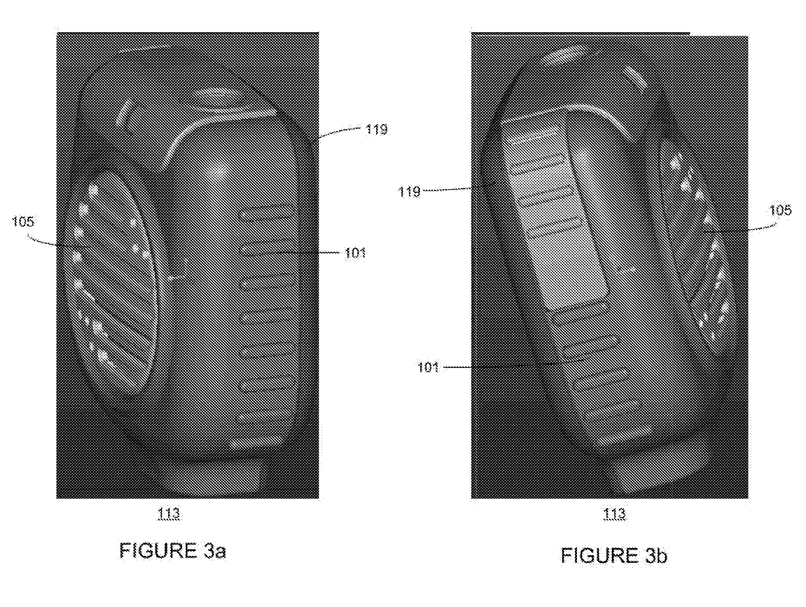

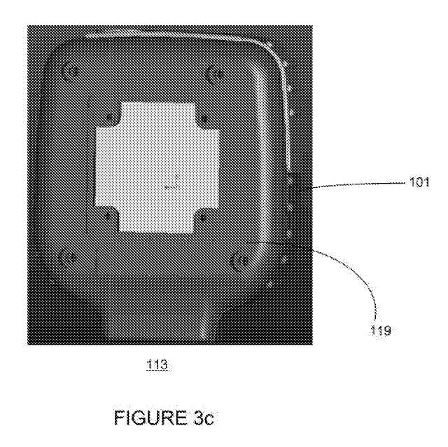

Referring now to FIGS. 3a-b, side perspective views of the present teachings, in accordance with one embodiment are illustrated. As described above, in one embodiment, the housing grill 105 fits through the annular opening of the front housing element 101. In another embodiment, the housing grill 105 is disposed entirely within the annular opening of the front housing element 101 and does not protrude beyond a plane defined by a front portion of the annular opening of the front housing element 101.

FIG. 3c illustrates a rear plan view of the communication channel activation switch apparatus 113, according to one embodiment of the present teachings.

When fully assembled, the communication channel activation switch apparatus 113 is useful for field operations. Exemplary field operation uses comprise, inter alia, emergency response personnel and military personnel. In field operations a user may have normal dexterity restricted due to a variety of conditions, such as for example a user is wearing gloves. Also, a user may have reduced visibility due to smoke or dust, reducing a user's ability to find a small switch. The communication channel activation switch apparatus 113 facilitates ease of opening an audio communication channel when a user so desires, by providing a larger surface area of contact for a user to depress and activate a switch.

In one embodiment, the communication channel activation switch apparatus 113 is adapted for use in a global positioning system (“GPS”). In this embodiment, the communication channel activation switch apparatus 113 is adapted to activate a two-way radio communication channel, for transmission and/or reception of, inter alia, audio and data information via the communication channel. In one embodiment, when a user desires to transmit audio information, the user applies mechanical pressure to the housing grill 105, which causes the speaker element 107 to activate the switching element 117. Activation of the switching element 117 may be achieved via mechanical switching, inductive activation, or capacitive activation. In one embodiment, the communication channel activation switch apparatus comprises a push-to-talk (“PTT”) speaker-microphone unit, useful in a GPS speaker-microphone assembly. In this embodiment, a communication channel to a microprocessor is established when the switching element 117 is activated.

In some embodiments, the communication channel activation switch apparatus 113 is adapted for use in literally any kind of communication channel. In one example, a communication channel for which the communication channel activation switch apparatus 113 is adapted for use comprises a channel from the microphone element 127 to an electronic processing element, such as for example a microprocessor. In another exemplary embodiment, an existing two-way radio communication channel is directly connected to when the switching element 117 is activated.

The present teachings are particularly useful when applied in a two-way radio system, which are typically half-duplex. A half-duplex communication system is capable of transmitting in either direction, but not simultaneously. As mentioned above, according to one embodiment, a user activates a connection to the communication system (e.g., two-way radio system) by applying mechanical pressure to the housing grill 105, which applies a force to the speaker element 107, thereby causing the speaker element 107 to activate the switching element 117, which activates the microphone element 127. Also, as noted above, a user may be wearing a glove (e.g., firefighter, soldier) when activating a connection to the communication system. The present teachings avoid a potential issue of a user blocking audio signals originating from the speaker (therefore being unable to hear such audio signals), because when a user is applying mechanical pressure to the housing grill 105 (and thereby potentially acoustically blocking the speaker element 107), a one-way connection to the communication system is established (i.e., transmitting to the communication system). Hence, when used in a duplex system, the present teachings overcome the issue of a user blocking audio signals from the speaker element 107, because when mechanical pressure is applied to the housing grill 105, the microphone element 127 is activated to transmit to the two-way radio system, and the speaker element 107 is effectively “disabled” during such transmission. Moreover, the microphone element 127 is located in such a manner, that there is no interference with a user sending audio signals to the microphone element 127 when a user is applying mechanical pressure to the housing grill 105, thereby activating a connection to the communication system.

Those skilled in the art will appreciate that the present teachings may be practiced with other system configurations, including hand-held devices, multiprocessor systems, microprocessor-based or programmable consumer electronics, network PC's, minicomputers, mainframe computers, and the like. The present teachings may also be practiced in distributed computing environments where tasks are performed by remote processing devices that are linked through a communications network. In a distributed computing environment, program modules may be located in both local and remote memory storage devices.

The communication systems described herein above may operate in a networked environment using logical connections to one or more remote computers. These logical connections can be achieved using a communication device that is coupled to or be a part of the computer; the present teachings are not limited to a particular type of communications device. The remote computer may be another computer, a server, a router, a network PC, a client, a peer device or other common network node, and typically includes many or all of the elements described above relative to the computer. The logical connections include a local-area network (LAN) and a wide-area network (WAN). Such networking environments are commonplace in office networks, enterprise-wide computer networks, intranets and the Internet, which are all types of networks.

When used in a LAN-networking environment, the computer is connected to the local network through a network interface or adapter, which is one type of communications device. When used in a WAN-networking environment, the computer typically includes a modem, a type of communications device, or any other type of communications device for establishing communications over the wide area network, such as the Internet.

The foregoing description illustrates exemplary implementations, and novel features, of aspects of an apparatus for broadcasting positioning information. Alternative implementations are suggested, but it is impractical to list all alternative implementations of the present teachings. Therefore, the scope of the presented disclosure should be determined only by reference to the appended claims, and should not be limited by features illustrated in the foregoing description except insofar as such limitation is recited in an appended claim.

While the above description has pointed out novel features of the present disclosure as applied to various embodiments, the skilled person will understand that various omissions, substitutions, permutations, and changes in the form and details of the present teachings illustrated may be made without departing from the scope of the present teachings.

Each practical and novel combination of the elements and alternatives described hereinabove, and each practical combination of equivalents to such elements, is contemplated as an embodiment of the present teachings. Because many more element combinations are contemplated as embodiments of the present teachings than can reasonably be explicitly enumerated herein, the scope of the present teachings is properly defined by the appended claims rather than by the foregoing description. All variations coming within the meaning and range of equivalency of the various claim elements are embraced within the scope of the corresponding claim. Each claim set forth below is intended to encompass any apparatus or method that differs only insubstantially from the literal language of such claim, as long as such apparatus or method is not, in fact, an embodiment of the prior art. To this end, each described element in each claim should be construed as broadly as possible, and moreover should be understood to encompass any equivalent to such element insofar as possible without also encompassing the prior art. Furthermore, to the extent that the term “includes” is used in either the detailed description or the claims, such term is intended to be inclusive in a manner similar to the term “comprising”.

What is claimed is:

1. An apparatus for activating a communication channel adapted for use in a communication system, comprising:
a) a switching element, adapted to activate a communication channel;
b) a housing, comprising:
i) a front housing element, mechanically connected to a housing grill, wherein the housing grill is adapted to fit a speaker element therein;
ii) a tension ring, mechanically coupled to the speaker element, wherein the tension ring is adapted to provide a restoring force;
iii) a back housing element, mechanically coupled to the front housing element, wherein the back housing element comprises the switching element disposed therein.

2. The apparatus of claim 1, wherein the tension ring is a spring having a spring constant “k”.

3. The apparatus of claim 2, wherein the speaker element is adapted to activate the switching element.

4. The apparatus of claim 3, wherein the communication channel comprises an audio channel.

5. The apparatus of claim 3, wherein the communication channel comprises a data channel.

6. The apparatus of claim 3, wherein the communication channel comprises a two-way radio communication system.

7. The apparatus of claim 3, wherein the switch element is further adapted to connect to a GPS system.

8. A means for activating a connection to a communication channel, comprising:
a) a switching means, operatively coupled to the communication channel;
b) a speaker means, having a first position and a second position, operatively associated with the switching means, for providing a mechanical pressure from the speaker means to the switching means, whereby the first position comprises a position wherein no mechanical pressure is applied thereto, and the second position comprises a position wherein mechanical pressure is applied to the speaker means;
c) a tension means, responsive to mechanical pressure from the speaker means, for restoring the speaker means from the second position to the first position.

9. The means of claim 8, wherein the tension means comprises spring means having a spring constant “k”.

10. The means of claim 9, wherein the speaker means is adapted to activate the switching means.

11. The means of claim 10, wherein the communication channel comprises an audio channel.

12. The means of claim 10, wherein the communication channel comprises a data channel.

13. The means of claim 10, wherein the communication channel comprises a two-way radio communication system.

14. The means of claim 10, wherein the switch means is further adapted to connect to a GPS system.

15. A system for opening a channel in a communication system, comprising;
a) a switching element, adapted to open a communication channel to a communication system;
b) a switching element housing, comprising:
i) a front housing element, mechanically connected to a housing grill, wherein the housing grill is adapted to fit a speaker element therein;
ii) a tension ring, mechanically coupled to the speaker element, wherein the tension ring is adapted to provide a restoring force;
iii) a back housing element, mechanically coupled to the front housing element, wherein the back housing element comprises the switching element disposed therein.

16. The system of claim 15, wherein the speaker element is adapted to activate the switching element.

17. The system of claim 16, wherein the communication channel comprises an audio channel.

18. The system of claim 16, wherein the communication channel comprises a data channel.

19. The system of claim 16, wherein the communication channel comprises a two-way radio communication system.

20. The system of claim 16, wherein the switch element is further adapted to connect to a GPS system.
